(19) United States
(12) Patent Application Publication
(10) Pub. No.: US 2019/0043124 A1
(43) Pub. Date: Feb. 7, 2019

(54) SYSTEM AND METHOD FOR A SINGLE POINT OF ENTRY DEPOSIT

(71) Applicant: EFT NETWORK, INC., Hawthorne, NY (US)

(72) Inventors: Steven Davis, Ossining, NY (US); Michael Davison, White Plains, NY (US); Martin Klamen, Teaneck, NJ (US); James Derivan, Nyack, NY (US); Bobby Ballard, Peekskill, NY (US); Stephen Wangner, Hicksville, NY (US); Roz Del La Rosa, Fort Lee, NJ (US); Charanjit Singh, Bridgewater, NJ (US)

(21) Appl. No.: 16/148,674

(22) Filed: Oct. 1, 2018

Related U.S. Application Data
(63) Continuation-in-part of application No. 10/811,093, filed on Mar. 26, 2004.

(51) Int. Cl. G06Q 40/02; G06Q 20/04

(52) U.S. Cl. CPC G06Q 40/02; G06Q 20/042

(57) ABSTRACT

Described is a method and system for single point deposit of checks. First, a computer scans each of a plurality of checks to generate digitized images thereof, the plurality of checks including at least one of non-consumer checks and consumer checks. After scanning the checks, the computer generates a master file including a record for each check which includes the digitized image of the corresponding check and a data portion including data obtained from a MICR line of the corresponding check. Once the masterfile is created, it is sorted into first and second sub-files based on the digitized images and/or the data portions. The first sub-file includes only the non-consumer checks and the second sub-file includes the consumer checks. The records of the first sub-file are processed according to a non-consumer check procedure. The records of the second sub-file are processed according to a consumer check procedure or the non-consumer check procedure.

### FIELD OF THE INVENTION

The invention generally relates to technology used in banking, especially technology by which paper checks are remotely deposited.

### BACKGROUND

By way of background, referring to 2004: U.S. Banking system allows processing of many types of electronic payments, including those made by consumer and non-consumer checks. The payments made with non-consumer checks have different processing procedures than those made with consumer checks. Thus, a creditor who receives both types of checks must manually sort the checks in order to separate the non-consumer checks from the consumer checks before they are processed.

Subsequently, the creditor must deposit the consumer checks in a different manner than the non-consumer checks. For example, the creditor may deposit the consumer checks by entering the corresponding transaction information (e.g., ABA No., account No., check No., etc.). However, the non-consumer checks must be deposited manually.

The industry standard for check sorting since the 1970s has been an IBM 3890 machine into which are fed large quantities of 6-inch paper checks; but only checks of length 6 inches (consumer-check-sized)—can be fed into the IBM 3890 machine. The IBM 3890 machine reads the magnetic ink character (MICR) and/or the optical characters (OCR) on each check, and sorts them into pockets; the machine moves the 6-inch checks at a rate of 2400 checks per minute. The IBM 3890 machine is quite big and includes feeders, modules, cabling, electronics, and other physical parts. The IBM 3890 machine has a large input area, which can accommodate 4800 incoming checks. Incoming checks are subjected to “jogging” to get the paper checks to be better lined up to go into the machine properly; sometimes an external jogging device is also used to further jog the ingoing paper checks. On the output end are 1-6 stackers; each stacker has six pockets; the machine's own sort control program directs each paper check to a pocket. From there, the paper checks are collected from the pockets and stored in trays.

Each bulky IBM 3890 check-sorting machine includes a mainframe computer and has a price-tag of about $1 million. An IBM 3890 check sorter is about 5 feet wide and 40 feet long. The IBM 3890 check sorter has been part of the industry-standard approach to paper checks needing to be deposited. IBM 3890 check sorter machines tend to be operated in sets. An example is a set of sixteen IBM 3890 check sorter machines operated by Huntingdon Bank. IBM 3890 machines operate by indorsing the paper checks and sorting the checks by routing number, to presort the paper checks before the paper checks are sent forward to a next geographic location as part of the clearing process needed for deposit.

Many users of the IBM 3890 machines are so-called Lockbox processors. Examples of Lockbox processors are those who receive paper checks paying Amex, cable TV companies or utilities. Large quantities of of paper checks arrive at a geographic location where the big IBM 3890 machines are operated. The Lockbox processors are charged less by the Federal Reserve (“Fed”) if the physical checks are presorted beforehand versus the higher charges imposed for a random mass of paper checks that arrive at the Fed. Also, by using the IBM 3890 check-sorting machines, some pairs of banks do their own trading directly between each other, of couriered bundles of bank-specific paper checks. By couriering bundles to each other, those pairs of banks lower their costs compared to if charges had been incurred for using the Fed's computerized systems to clear those “traded” paper checks. When using the IBM 3890 check sorters, there is the ubiquitous need for Lockbox processors to courier paper checks forward to another geographic location to accomplish deposit.

Another aspect of using IBM 3890 machines is that manual sorting of non-consumer paper checks (bigger than 6 inches) from consumer paper checks (6 inch checks) is ubiquitous and necessary when Lockbox processors use the IBM 3890. An 8½ inch check (a common size of a non-consumer check) that arrives to a Lockbox processor cannot go into the IBM 3890.

The way that the paper checks get into the trays (which trays are then fed by a human operator into the IBM 3890 check sorter) is as a result of another machine, an Opex machine, having been operated to open incoming mail and extract the checks from the envelopes and get the checks ready to go into the trays that the IBM 3890 check scanner can receive. The Opex machine deals with metal objects (which cannot go into the IBM 3890 check sorter) in the incoming mail. The Opex-processed checks go into trays that can be picked up by a human operator and taken over to the IBM 3890 check sorter machine.

There is a need for a single point of entry deposit system that would eliminate the need for a physical sorting of checks and allow creditors to deposit both types of checks electronically.

### SUMMARY OF THE INVENTION

The present invention relates to a system and method for a single point of entry deposit for financial instruments (e.g., checks, etc.). Checks of all categories/types (e.g., consumer and non-consumer checks) may be scanned into a computer which then digitizes the checks into check records and stores the records in a masterfile. The computer then separates the records into a first subfile for non-consumer checks and a second subfile for consumer checks. The first subfile is then processed according to non-consumer check procedures. The second subfile may be processed according to consumer check procedures or the non-consumer check procedures.

In addition, a system for depositing checks may include a database storing information corresponding to debtors, a master file including a set of records for a plurality of checks received from the debtors. Each record corresponds to one of the checks and includes a digitized image of the corresponding check and data obtained from a MICR (Magnetic Ink Character Recognition) line of the corresponding check. Each record is categorized a non-consumer check or a consumer check based on the digitized image, the data and/or the information in the database. The first subfile includes a first subset of the records corresponding to checks categorized as non-consumer checks. The second subfile includes a second subset of the records corresponding to checks categorized as consumer checks.

Furthermore, a system includes an image capturing device configured to capture a digitized image of a check and a processor. The processor extracts data from the digitized image of the check and categorizes the check as one of a non-consumer check and a consumer check based on the digitized image and/or the extracted data. The processor stores the digitized image and the data in a first file when the check is categorized as a non-consumer check and in a second file when the check is categorized as a consumer check.

The invention in a preferred embodiment provides a method, comprising the steps of: scanning each of a plurality of checks to generate digitized images thereof (such as, e.g., digitized images of the checks that include images of at least one of a front and a rear of the checks), the plurality of checks including at least one of non-consumer checks and consumer checks; generating a master file including a record for each check, each record including the digitized image of the corresponding check and a data portion including data obtained from a MICR line of the corresponding check; sorting the records into first and second sub-files as a function of at least one of the digitized images and the data portions, the first sub-file including only the non-consumer checks and the second sub-file including only the consumer checks; processing the records included in the first sub-file according to a non-consumer check procedure to settle transactions referenced by each of the checks corresponding to the records in the first sub-file; and processing the records included in the second sub-file according to one of a consumer check procedure (such as, e.g., a consumer check procedure that includes processing of the second sub-file to forward it to a clearing network for a settlement) and a non-consumer check procedure (such as, e.g., a non-consumer check procedure that includes electronically submitting the first sub-file to a financial institution, the financial institution generating an image replacement document for each of the non-consumer checks and submitting the image replacement document for a settlement; a non-consumer check procedure that includes electronically submitting the first sub-file to a first financial institution, the first financial institution forwarding the first sub-file to a second financial institution for settlement; etc.) to settle transactions referenced by each of the checks corresponding to the records in the second sub-file, such as, e.g., inventive methods wherein the first and second sub-files are processed separately; inventive methods wherein the data portion further includes an amount of the check derived form the corresponding digitized image; inventive methods further comprising the step of verifying the sorting step using information stored in a database of debtors; inventive methods further comprising the step of displaying each of the records in the master file, the display including one of the data portion, a snippet of the digitized image, a digital amount of the check and a categorization of the check (such as, e.g., inventive methods wherein a user is permitted to alter the displayed record); inventive methods further comprising the step of storing the data portion of each of the records in a database (such as, e.g., a database that includes one of a debtor's name, a debtor's account number, a debtor's address, a debtor's ABA number, a debtor's account payable amount), the database being organized by debtors and each of the records corresponding to one of the debtors; and other inventive methods.

In another preferred embodiment, the invention provides a system comprising: an image capturing device configured to capture a digitized image of a check; a processor configured to extract data from the digitized image of the check and further configured to categorize the check as at least one of a non-consumer check and a consumer check as a function of at least one of the digitized image and the extracted data, wherein the processor stores the digitized image and the data in a first file when the check is categorized as a non-consumer check and in a second file when the check is categorized as a consumer check, such as, e.g., inventive systems wherein the digitized image includes a MICR line from which the data is extracted (such as, e.g., inventive systems wherein the processor categorizes the check based on the position of the data on the MICR line); and other inventive systems.

The invention in another preferred embodiment provides a system for depositing checks, comprising: a database storing information corresponding to debtors; a master file including a set of records for a plurality of checks received from the debtors, each record corresponding to at least one of the checks, each record including a digitized image of the corresponding check and data obtained from a MICR line of the corresponding check, wherein each record is categorized as corresponding to one of a non-consumer check and a consumer check, the categorization being a function of at least one of the digitized image, the data and the information in the database; a first subfile including a first subset of the records, the first subset including records corresponding to checks categorized as non-consumer checks; and a second subfile including a second subset of the records, the second subset including records corresponding to checks categorized as consumer checks, such as, e.g., inventive systems wherein the records included in the first subfile are processed according to a non-consumer check procedure to settle transactions referenced by each of the checks corresponding to the records in the first subfile; inventive systems wherein the records included in the second subfile are processed according to a consumer check procedure to settle transactions referenced by each of the checks corresponding to the records in the second subfile; inventive systems wherein the categorization of the checks is verified using the information in the database; inventive systems wherein the records of the master file are displayed to a user; inventive systems wherein the database is updated using the data obtained from the check; and other inventive systems.

In another preferred embodiment, the invention provides for format-analyzing of a MICR line (i.e., MICR-font line), performed on each check in a batch of different-sized paper checks that have been scanned into a single point of entry.

The invention in another preferred embodiment provides a method of remote check deposit, comprising scanning different-sized consumer checks and non-consumer checks into a single point of entry (such as, e.g. a single scanner which is not an IBM 3890).

In another preferred embodiment, the invention provides for a method of remote deposit of a paper check, regardless of whether the check is consumer or non-consumer, without use of an IBM 3890 check sorter machine, and wherein remote deposit is fully accomplished without needing to courier the paper check forward to another geographic location.

The invention in another preferred embodiment provides a method of remote deposit of a batch of paper checks, without manual sorting of the non-consumer checks and the consumer checks prior to deposit. That the method is “without manual sorting of the non-consumer checks and the consumer checks prior to deposit” imparts that paper checks bypass and avoid the manual sorting of non-consumer checks from consumer checks that, before the invention, was ubiquitous and necessary when Lockbox processors used the IBM 3890, and connotes that the non-consumer checks and the consumer checks are together in one batch.

In another preferred embodiment, the invention provides a remote check deposit method by which is deposited a Mixed Batch of checks comprising both a consumer check and a non-consumer check each comprising a Magnetic Ink Character Recognition (MICR) line comprising MICR-font characters, each MICR line having a format, without manual sorting of the non-consumer checks and the consumer checks prior to deposit, comprising: scanning, into a single point of entry (such as, e.g., a single point of entry that is a desktop machine; etc.), the Mixed Batch of checks including the consumer check and the non-consumer check; followed by electronically depositing both the consumer check and the non-consumer check, provided that no manual sorting of consumer checks from non-consumer checks has been performed before deposit, such as, e.g., inventive method wherein the Mixed Batch comprises at least one consumer check having a size of US currency, and at least one business check having a size substantially larger than US currency; inventive methods wherein the checks are not situated in any tray prior to the scanning step; inventive methods in which the checks are not situated in any tray at any time before deposit; inventive methods wherein the Mixed Batch of checks comprises at least 100 checks, some of which are consumer checks and some of which are non-consumer checks, wherein the step of electronically depositing is accomplished for each and every check in the Mixed Batch; inventive methods wherein the Mixed Batch of checks comprises at least 1,000 checks, some of which are consumer checks and some of which are non-consumer checks, wherein the step of electronically depositing is accomplished for each and every check in the Mixed Batch; inventive methods wherein the Mixed Batch comprises at least one check of a first length, and at least one check of a second length that is longer than the first length (such as, e.g., inventive methods wherein the Mixed Batch further comprises at least one check of a third length that is longer than the second length; inventive methods wherein the Mixed Batch comprises at least one check of a first width, and at least one check of a second width that is longer than the first width; etc.); inventive methods wherein the Mixed Batch comprises checks having a MICR line that consists of magnetic ink; inventive methods wherein the Mixed Batch comprises checks having a MICR line free of magnetic ink; inventive methods wherein the Mixed Batch comprises checks having a MICR line that consists of magnetic ink and checks having a MICR line free of magnetic ink; and other inventive methods.

### BRIEF DESCRIPTION OF THE DRAWINGS

The accompanying drawings are included to provide a further understanding of the invention and are incorporated into and constitute part of the specification, illustrate several embodiments of the invention and, together with the description, serve to explain examples of the present invention. In the drawings:

FIG. 1 shows an exemplary system according to the present invention for a single point of entry deposit;

FIG. 2 shows an exemplary method according to the present invention for a single point of entry deposit;

FIG. 3 shows a method for digitizing checks according to the present invention;

FIG. 4 shows a method according to the present invention for sorting checks into a first subfile and a second subfile based on the check's categories;

FIG. 5 shows a screenshot of an exemplary embodiment of a software application according to the present invention;

FIG. 6 shows a method for depositing non-consumer check records stored in the first subfile according to the present invention;

FIG. 7 shows a method for depositing consumer check records stored in the second subfile according to the present invention;

FIG. 8 shows an exemplary embodiment of a digital check record;

FIG. 9 shows a flow chart diagram of processing checks according to the present invention; and

FIG. 10 shows another exemplary embodiment of a system according to the present invention for a single point of entry deposit.

### DETAILED DESCRIPTION

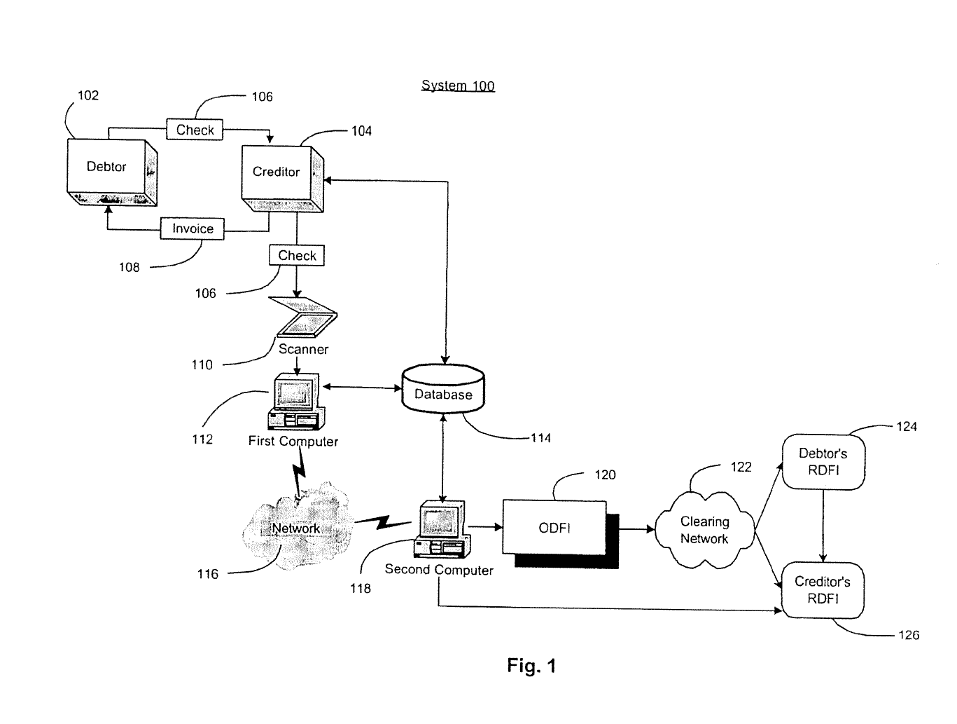

FIG. 1 shows an exemplary embodiment according to the present invention of a system 100 for a single point of entry deposit of financial instruments (e.g., a check, a traveler's check, a money order, etc.). The system 100 may include a creditor 104 (e.g., an individual, an organization, a corporation, etc.) which receives payments in the form of a check 106 from a debtor 102 (e.g., an individual, an organization, a corporation, etc.). Each creditor 104 may have a plurality of debtors 102; information regarding the debtors 102 may be stored in a database 114. In particular, database 114 may contain information, such as contact data for the debtors 102 (e.g., names, addresses, phone numbers, etc.), goods and/or services provided, amount owed, financial institution information, or any other data that creditor 104 may require. In the alternative exemplary embodiment, database 114 may include a plurality of databases situated in one or more locations; each database may be storing particular type of data and some databases may be storing overlapping data. Database 114 may be accessible by a first computer 112 (e.g., a computing arrangement that has basic input and output devices as well as memory and storage devices). First computer 112 enables creditor 104 to perform a variety of computing tasks, such as manage database 114 and run software applications. First computer 112 may also be connected to a computer communication network 116 which may be any type of a computing network (e.g., a local area network, a wireless area network, the Internet, etc.). First computer 112 may be operated by creditor 104 or a third party responsible for the depositing of checks received by creditor 104.

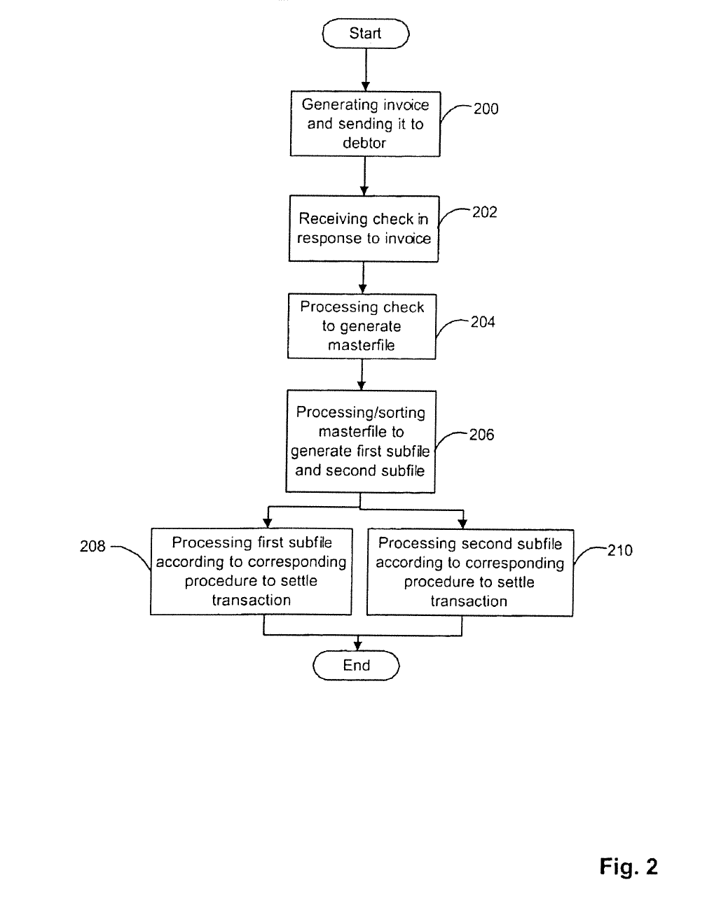

System 100 is also described in conjunction with FIG. 2 which shows an exemplary embodiment of a method according to the present invention. In step 200, creditor 104 generates and sends an invoice 108 to debtor 102. The invoice 108 notifies debtor 102 that a payment is due for particular goods and/or services provided by creditor 104 and/or a third party provider. The invoice 108 may be generated based on data entered manually (e.g., by creditor 104) or obtained automatically (e.g., from database 114). After invoice 108 is sent to debtor 102, database 114 is updated to reflect the invoice data.

Invoice 108 is only one of a plurality of means of apprising debtor 102 of the outstanding debt. For instance, debtor 102 may have a regular business relationship with creditor 104 in which creditor 104 supplies debtor 102 with goods and/or services on a regular basis pursuant to a contract (e.g., monthly, weekly, etc.). In another instance, debtor 102 has a contractual obligation to pay creditor 104 on a periodic basis (e.g., monthly) and does not require a separate monthly notice in form of the invoice 108. In an alternative embodiment of the present invention, debtor 102 may be donor which as chosen to send an unsolicited donation to a charity or not-for-profit organization; the unsolicited donation would need to be accompanied by a notification of truncation/conversion of check 106. Thus, the step 200 of generating an invoice 108 may be optional.

In step 202, creditor 104 receives check 106 from debtor 102 either in response to invoice 108 or for other purposes some of which were described above. Check 106 may be one of two categories/types: a first type of check drawn on a consumer account (e.g., a personal checking account); or a second type of check drawn on a non-consumer account (e.g., a business checking account, a third-party business account). It should be noted that the accounts of both debtor 102 and creditor 104 may be at the same or different financial institutions. The process of depositing checks 106 may depend on the type of check. However, the exemplary embodiment of the present invention allows creditor 104 to electronically deposit checks 106, regardless of their type (i.e., consumer or non-consumer checks).

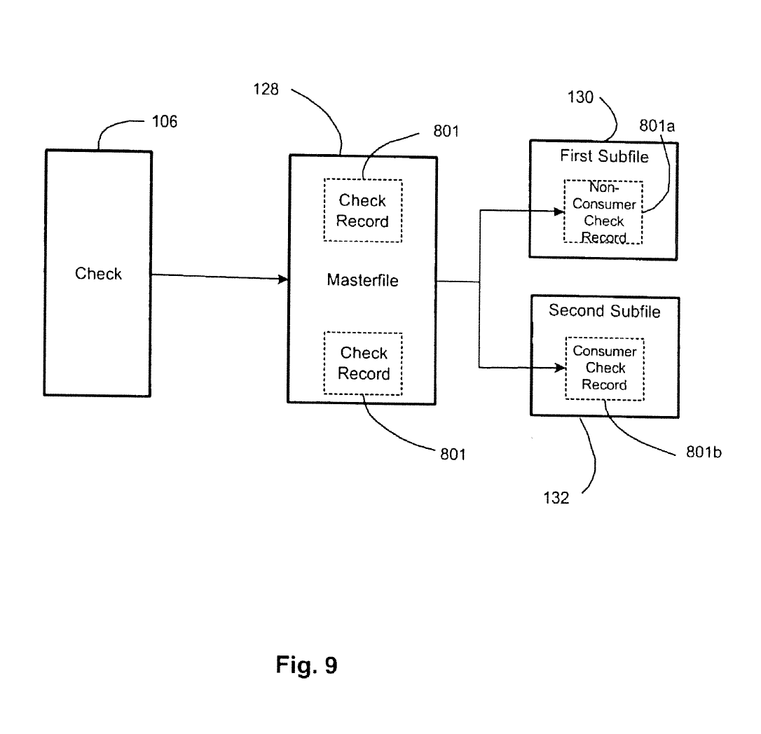

In step 204, creditor 104 processes check 106 in order to generate a digital masterfile 128 as shown in FIG. 9. Masterfile 128 contains a record 801 for each of the checks 106. An exemplary record 801 is shown in FIG. 8. The exemplary record 801 is for a non-consumer check. Record 801 may include a digitized image of check 106 (i.e., a front image 812 and a rear image 814) as well as other check data such as an amount 810, an ABA number 804, an account number 806, a check number 802, and other information (i.e., the date when check 106 was written or prepared for deposit; data obtained from MICR line 800). Some of the check data may be obtained from a MICR line 800 as discussed in greater detail below. Those of skill in the art will understand that consumer checks may have the same format or a different format from the exemplary non-consumer check illustrated in FIG. 8.

Record 801 may be obtained by scanning check 106 using an image capturing device (e.g., scanner 110). Scanner 110 may be connected as a peripheral device to first computer 112 or integrated into first computer 112. Once checks 106 are scanned through scanner 110, first computer 112 captures MICR line 800, front image 812 and rear image 814. Then the first computer (or, in alternative, the second computer 118) parses and analyzes front image 812 and rear image 814 as well as the check data (e.g., 802, 804, 806, 810, etc.) collected during the scan and may store it in masterfile 128. Those skilled in the art would understand that masterfile 128 may include just a single check or a plurality of checks of either or both types.

As shown in FIG. 9, masterfile 128 may include check records 801 for multiple checks 106 received by creditor 104. The processing is accomplished via specialized software which may be installed on first computer 112 or may be run remotely via second computer 118 (e.g., through a web browser). If the specialized software is installed on first computer 112, then most of the algorithms and logic for processing the checks is resident on first computer 112. If the specialized software is operated remotely, then the algorithms are performed by second computer 118. The processing of capturing the check data for masterfile 128 is described in greater detail below.

In step 206, records 801 of masterfile 128 are subjected to additional processing to sort each record 801. Masterfile 128 may be processed by first computer 112 or it may be transmitted for further processing to a second computer 118 through network 116, depending where the processing software is located. In the exemplary embodiment of FIG. 1, the processing of masterfile 128 is accomplished by second computer 118 which may have the same capabilities as first computer 112 (e.g., connection to network 116, sufficient storage, etc.). Second computer 118 may also have access to database 114. The dual computer arrangement shown in FIG. 1 is an exemplary embodiment of the present invention. It is possible to accomplish steps 204 and 206 by using a single computer (e.g., using only first computer 112 or second computer 118) or any number of computers.

If the processing of masterfile 128 is done on first computer 112, then second computer 118 may be only used to connect to ODFI 120. Those of skill in the art will understand that there may be various computing and networking arrangements used to accomplish the process described with reference to FIG. 2. As described above, creditor 104 may perform all the steps or it may delegate some or all of the duties of preparing checks 106 for deposit to a third party (e.g., a data processing entity).

In step 206, masterfile 128 is processed and sorted in order to separate non-consumer check records 801a into first subfile 130 and consumer checks records 801b into second subfile 132 as shown in FIG. 9. According to the present invention, the sorting is done once records 801 have been created and stored in masterfile 128, thus, eliminating the need for creditor 104 to manually sort the non-consumer and consumer checks 106 prior to deposit. If the processing software is installed on first computer 112, then first computer 112 generates first and second subfiles 130, 132. However, if the processing software is located on second computer 118, second computer 118 processes masterfile 128 to generate first and second subfiles 130, 132. The sorting process is described in greater detail below.

After the sorting of masterfile 128 into first subfile 130 containing non-consumer check records 801a and second subfile 132 containing consumer check records 801b, first subfile 130 may be processed pursuant to non-consumer check procedures (e.g., as defined by the U.S. Banking Regulations) as discussed in step 208 and second subfile 132 may be submitted for processing pursuant to consumer check procedures as discussed in step 210. First and second subfile 130, 132 are submitted to an Original Deposit Financial Institution (“ODFI”) 120 by second computer 118. It should be noted that second computer 118 and the ODFI may be owned by the same or separate entities. For example, ODFI 120 may be a financial institution that is providing the deposit services to creditor 104. ODFI 120 may follow specific procedures in depositing the consumer and non-consumer checks.

In step 208, second computer 118 may process the non-consumer checks by sending first subfile 130 containing non-consumer check records 801a directly to the creditor's receiving deposit financial institution (“RDFI”) 126 or a third party's RDFI. Alternatively, RDFI 126 may print the non-consumer check records 801a stored in first subfile 130 (e.g., create image replacement documents (“IRD”)) and manually deposit the IRDs. This process is described in more detail below.

In step 210, ODFI 120 deposits the consumer checks by transmitting second subfile 132 to Clearing Network 122 (e.g., the ACH Network, Federal Reserve Bank, a private clearing house). Clearing Network 122 settles each transaction by debiting the debtor's RDFI 124 for the amount 810 of the check 106 from the debtor's 102 checking account and by crediting the creditor's RDFI 126 by amount 810 to the creditor's 104 account. Thus, the exemplary system and method alleviates the need for creditor 104 to manually sort the received checks 106 and facilitates the deposit of the checks by creditor 104. Those skilled in the art would understand that second subfile 132 may be processed in accordance with procedures for non-consumer checks as described in step 208.

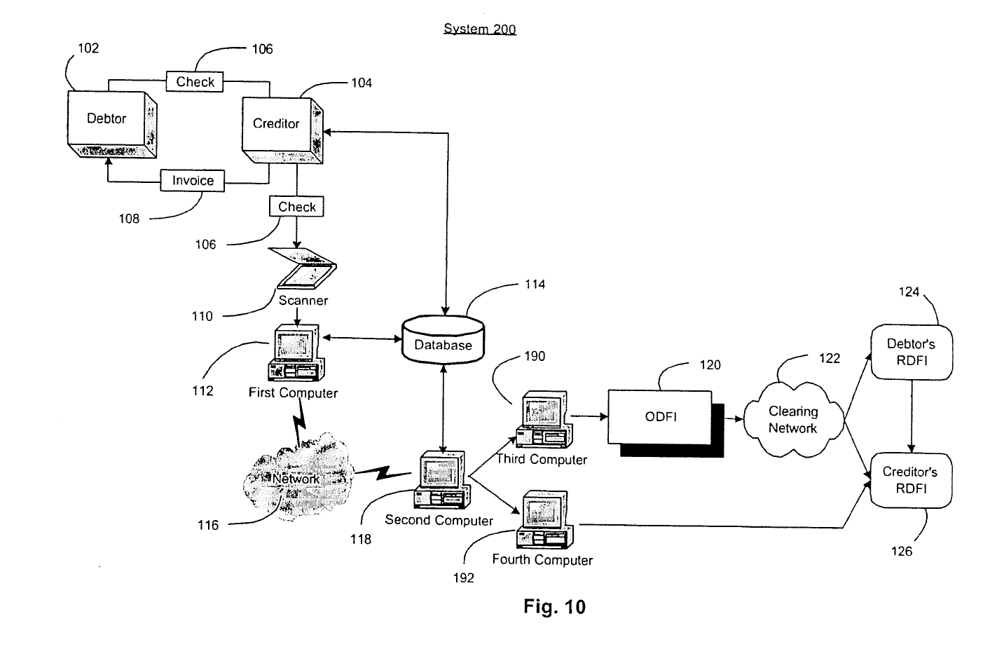

FIG. 10 shows another embodiment of a system 200 for single point of entry deposit of checks according to the present invention. System 200 is substantially similar to system 100, except it contains a third computer 190 and fourth computer 192 connected to second computer 118. Second computer 118 may submit second subfile 132 to third computer 190 and first subfile 130 to fourth computer 192. Third computer 190 then transmits the consumer check data contained in second subfile 132 to ODFI 120. Fourth computer 192 send first subfile 130 containing non-consumer check records 801a directly to the creditor's RDFI 126. Thus, system 200 accomplishes the same goal as system 100 in step 208, except that system 200 uses additional computers. As stated above, the present invention may be implemented using any number of computing devices to facilitate processing and transmission of data associated with the deposit.

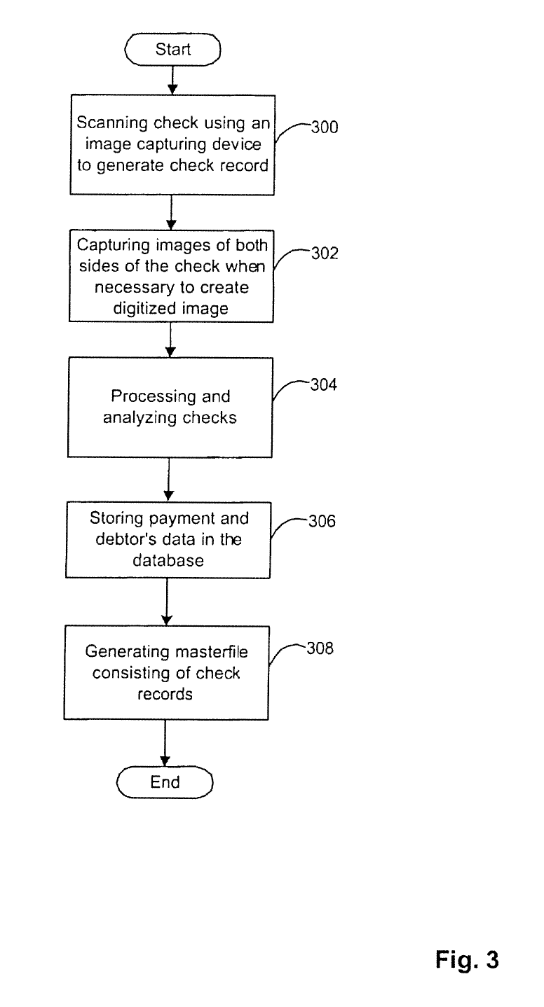

FIG. 3 shows a method for processing check 106 to obtain record 801 and create masterfile 128 as discussed with reference to step 204 of FIG. 2. As stated above, record 801 may include front image 812, rear image 814, MICR line 800, as well as the data extracted from MICR line 800 (e.g., ABA number 804, account number 806, check number 802), amount 810, and other miscellaneous data (e.g., the data the check was issued). Record 801 may also include data about debtor 102 (i.e., remaining balance, overdue payment, etc.) extracted from database 114 if there was a prior dealing between the parties.

In step 300, creditor 104 scans check 106 using scanner 110 or any other type of image capturing device connected to first computer 112. Scanner 110 may be a high-volume scanner capable of automatically scanning a large number of checks or a less sophisticated model that can scan one or a limited number of checks at a time. It is preferable that scanner 110 can capture both sides of check 106 at the same time. However, it is possible for scanner 110 to be able to scan only one side of check 106 at a time, in which case creditor 104 will have to scan the other side of check 106 when desired.

In step 302, a digitized image of each side of check 106 is captured to produce front image 812 and rear image 814. Front image 812 may contain the date that check 106 was written, the addresses of debtor 104 and debtor's RDFI 124, and the debtor's signature. Front image 812 also contains amount 810 and the information concerning the debtor's 102 account encoded in MICR line 800.

In step 304 the MICR line 800 of check 106 is processed and analyzed. MICR line 800 is located at the bottom of front image 812 and is typed in MICR font. MICR line 800 may consist of ABA number 804, account number 806, check number 802, and other symbols and/or fields. The standardized printing of MICR line 800 allows first computer 112 to recognize the numbers and characters contained therein, using a conventional character recognition software resulting in easy digitization of data 816. After MICR line 800 is parsed, the data is stored in record 801 along with front image 812 and rear image 814.

The information contained in MICR line 800 is essential for processing of the check. Every financial institution in the United States has a unique ABA number issued by the Federal Reserve. While a financial institution may have a multitude of ABA numbers, those ABA numbers are only associated with that particular financial institution. The account number is also a unique identification number issued by a financial institution to distinguish between a multitude of account-holders. Furthermore, each check issued from a particular financial institution account may have a check number. A combination of the above-described numbers often makes a check unique, thus allowing the settlement transaction to be carried out at least partially electronically (e.g., without presenting a physical proof of the financial instrument to a financial institution).

In addition to analyzing MICR line 800, first computer 112 may also analyze amount 810 located at the right side of front image 812. First computer 112 may use character recognition software to recognize handwritten amount 810 (or in some cases printed amount 810) and store it in a digital format in record 801. The character recognition analysis may encounter difficulties in converting handwritten amount 810, due to the unique nature of each person's writing style. Thus, the character recognition software may have a certain accuracy in determining amount 810 based on the analysis of the handwriting. Therefore, there may also be a manual final verification of amount 810. After verification, amount 810 is also stored in record 801. Furthermore, the software may also capture other information to include in record 801 such as the data of the check and the name and address on check 106.

After record 801 is created, first computer 112 may update database 114 in step 306. The updating step may include reporting of a discrepancy between amount 810 in record 801 and the amount expected by creditor 104, the correlation of the debtor's check number 802 to a particular invoice 180, the verification of the debtor's 102 name and address, etc. In addition, if this is the first check received from a particular debtor 102, the information (e.g., ABA number 804, account number 806, etc.) for debtor 102 may be added to database 114.

In step 308, masterfile 128 is generated. Masterfile 128 includes records 801 of every check 106 processed by first computer 112. Thus, masterfile 128 may include a plurality of data files and image files corresponding to each check which are combined into a single file as shown in FIG. 9.

As described with reference to FIG. 2, after masterfile 128 is created, it is processed to generate first and second subfiles 130, 132 (step 206 of FIG. 2). This step may be performed on a single computer (e.g., first computer 112 or second computer 118) or a plurality of computers as described above. In this example, the analysis and the sorting process are performed using a sorting software application running on second computer 118.

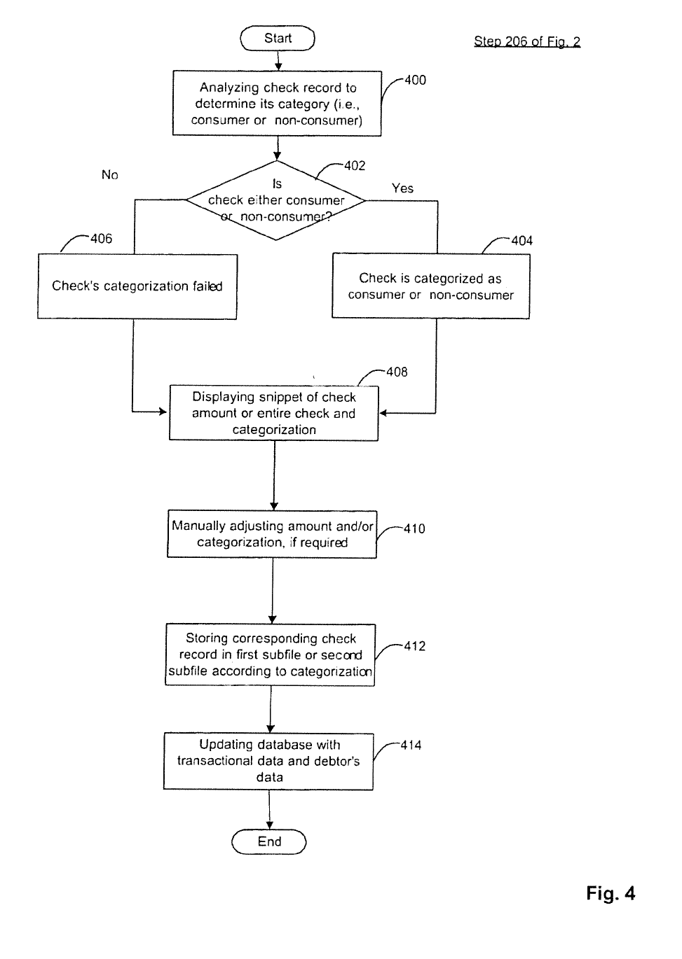

FIG. 4 shows an exemplary method for sorting checks 106 as described with reference to step 206 of FIG. 2. In step 400, the sorting software analyzes each record 801 contained in masterfile 128 to determine its category (i.e., a non-consumer check or a consumer check). This analysis may be accomplished in a number of different manners.

In one example, the sorting software may analyze a format of MICR line 800. Since each category of check generally uses a different format for MICR line 800 (i.e., positioning and spacing of the ABA number, the account number, and the check number). As described above, the exemplary check shown in FIG. 8 is the general format of a non-consumer check, i.e., MICR line 800 is formatted having check number 802 at the far left, followed by ABA number 804 and account number 806. For consumer checks (not shown), the format is generally the ABA number located at the far left followed by the account number and the check number. Thus, by reading the format of MICR line 800, the sorting software may determine whether the check is a consumer check or a non-consumer check.

When we refer herein to “format of the MICR line,” that means an arrangement of the MICR line, namely, how the ABA number, the account number, and the check number that appear on the MICR line are spaced and positioned relative to each other. Format of a MICR line is different than a MICR line's content (i.e., the numbers themselves). Only plucking a snippet of a MICR line, without more, is not within format-analyzing of a MICR line.

In another exemplary embodiment of the present invention, the non-consumer check shown in FIG. 8 illustrates the use of special characters surrounding ABA number 804 and check number 802. Conversely, for consumer checks, the special characters generally surround the ABA number and the account number. Thus, by reading the special characters, the sorting software may be able to determine whether the check is a consumer check or a non-consumer check. Those of skill in the art will understand that there may be other unique features of consumer checks and/or non-consumer checks that may be used to sort between the two types of checks.

Occasionally, a check may have a differently formatted MICR line that deviates from the accepted norms. As a result, the above-described analyses based on the format of MICR line 800 may be inconclusive and further analysis may be required. However, even if the sorting software concludes that check 106 is of a particular type, the sorting software may proceed with the further analysis to verify its own conclusion.

After completing the analysis of MICR line 800, the sorting software compares ABA number 804 and account number 806 with the information stored in database 114. If debtor 102 has previously sent a check to creditor 104 from the same checking account, then a record of that transaction is stored in database 114. Thus, if there is data of the previous transaction in database 114, the data will include information as to whether the account was a consumer account or a non-consumer account. The sorting software may search database 114 for ABA number 804 and account number 806 to find a match in the old payment records. If ABA number 804, account number 806 of check 106 match the ABA number and the account number of the previous check, then check 106 originated from the same account, hence its category is the same. Thus, the sorting software may verify its previous conclusion or come to an initial conclusion based on this checking.

Another example of a sorting method may use the amount of the check. For instance, the sorting software may utilize amount 801 to find a matching amount in one of the unpaid invoices 108. If such an invoice is found, the information about debtor 102 is obtained from database 114 and check 106 is categorized accordingly. For example, if amount 810 is for $701.32 and in database 114 the invoice 108 for $701.32, then there is a match. After the match is found and the information about debtor 102 is extracted, the sorting software categorizes check 106 according to the category of debtor 102. Thus, if debtor 102 is a non-consumer then check 106 is categorized as a non-consumer check. This categorization method only works in certain situations. For example, there is a possibility that the category of the check may not match the category of debtor 104 (e.g., a business owner paying with a consumer check). Furthermore, this sorting algorithm only works when there is a single invoice 108 that matches amount 810. Thus, if there are multiple invoices that match amount 810 or none of the invoices match amount 810, this analysis is inconclusive.

Regardless of whether or not the sorting software provides a definite result, the sorting software may run more sorting algorithms or move to the next step. However, if the sorting software is unable to determine whether check 106 is consumer or non-consumer, it will conclude its analysis and categorize check 106 using a default category. The default category may be consumer, non-consumer, or undefined and it may require manual categorization by the user.

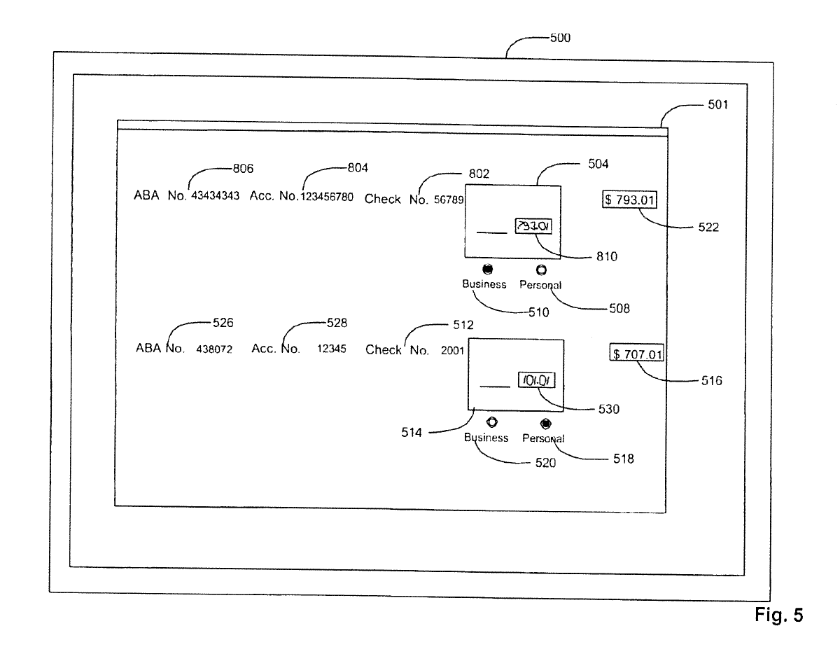

In step 402, the sorting software determines if the check is consumer or non-consumer based on the analysis described above. If the analysis is inconclusive, the categorization has failed, and in step 406, the sorting software does not categorize check 106. The sorting software may provide information about the check to creditor 104 and request or require manual adjustment of the check categorization as discussed below in step 408. If the sorting software was successful in categorizing check 106, then, in step 404, it stores in record 801 the corresponding category. Regardless of the categorization, in step 408, the computer displays the results of its analysis on a monitor 500 (e.g., as shown in FIG. 5), other display arrangements or output devices.

Monitor 500 can show every record 801 stored in masterfile 128. In particular, it can display the following information about check 106: account number 806, ABA number 804, check number 802 and other data discussed below. This step allows creditor 104 to verify that check 106 has been properly digitized. To aid the user in accomplishing that task the display includes a snippet 504. Snippet 504 is a digital image of a portion of check 106 centered around the amount 810. The display also shows the amount 810 as a digital amount 522. As discussed above, the digitization of amount 810 may not be precise and thus, the user may modify the digital amount 522 if it is incorrect (i.e., if the digital amount 522 is different from the amount 810 displayed in snippet 504). The size of snippet 504 varies with the size of the check so that it displays all of the relevant information. For instance, non-consumer checks are usually larger than consumer checks. Therefore, snippet 504 may display a larger portion of check 106 surrounding amount 810 if desired. Alternatively, snippet 504 may display the entire check 106 as desired by the user.

Monitor 500 further shows the categorization of check 106 if the sorting software was able to determine it in steps 400-402. If it is possible to determine the categorization of check 106, then in step 404 the sorting software selects either a “Consumer” field 508 or a “Non-consumer” field 510. For instance, if check 106 is a non-consumer check, then the “Non-consumer” field 510 is highlighted. However, if second computer 118 is not able to categorize the check then it will set the categorization to default (e.g., a non-consumer), allowing the user to select the proper field as explained below in regard to another check record.

In the example of FIG. 5, monitor 500 includes a digital check record of a second check which includes an account number 528, an ABA number 526, a check number 512, a snippet 514, and a digital amount 516. In this case, the digital amount 516 is different from an amount 530 being displayed in snippet 514. In addition, the “Consumer” field 518 is highlighted, since second computer 118 failed to categorize the check in step 406 and provided that the “Consumer” field 518 is the default category. The user may correct the digital amount 516 by changing it from $707.01 to reflect the sum of $101.01 shown in the amount 530 (Step 410). As discussed above, the user may also manually categorize the check by choosing the check's categorization based on the information supplied by snippet 514.

After check 106 is categorized, either by the user or the sorting software, record 801 is stored in a corresponding subfile, either the first or second subfile 130 of 132 (step 412). The first and second subfiles 130, 132 are similar to masterfile 128 since they also contain a collection of records 801. However, records 801 within either subfile 130 or 132 are of the same category, either non-consumer or consumer. If check 106 is a non-consumer check, then it is stored in first subfile 130. However, if check 106 is issued from a consumer bank account, then it is stored in second subfile 132. After first subfile 130 and second subfile 132 are generated, they are uploaded to ODFI 120 for a further processing.

In step 414, database 114 is updated with transactional data (e.g., ABA numbers, account numbers, contact information, etc.). Regular updates maintain database 114 so that it may be used during categorization of checks in the future as discussed above. For instance, during the amount-matching sorting algorithm, when the sorting software searches database 114 for invoices 108.

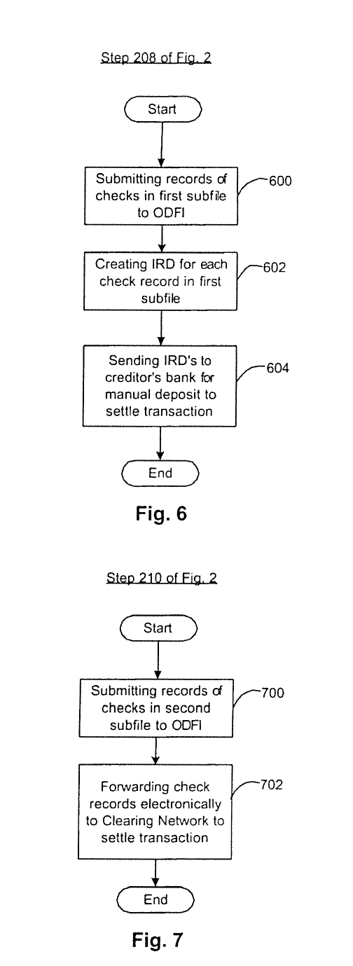

FIG. 6 shows an exemplary method according to the present invention for depositing non-consumer check records 801a stored in first subfile 130. In step 600, first subfile 130 is sent to ODFI 120 for processing. As previously described, non-consumer checks may not be entered into the Clearing Network 122. Therefore, in step 602, ODFI 120 utilizes different depositing procedures which may require image replacements documents (“IRD”) for each check from its corresponding check record. An IRD is created based on a check record, as shown in FIG. 8. It displays front side 812 and rear side 814 and in effect replaces check 106 (e.g., if check 106 was issued from a non-consumer account). An IRD also acts as a legal substitute for the original check. In step 604, ODFI 120 sends the IRD of check 106 to the creditor's RDFI 126 in order to settle the transaction referenced by check 106. Thus, the non-consumer checks are deposited in the same manner as if they were brought physically to the financial institution (e.g., creditor's RDFI 126).

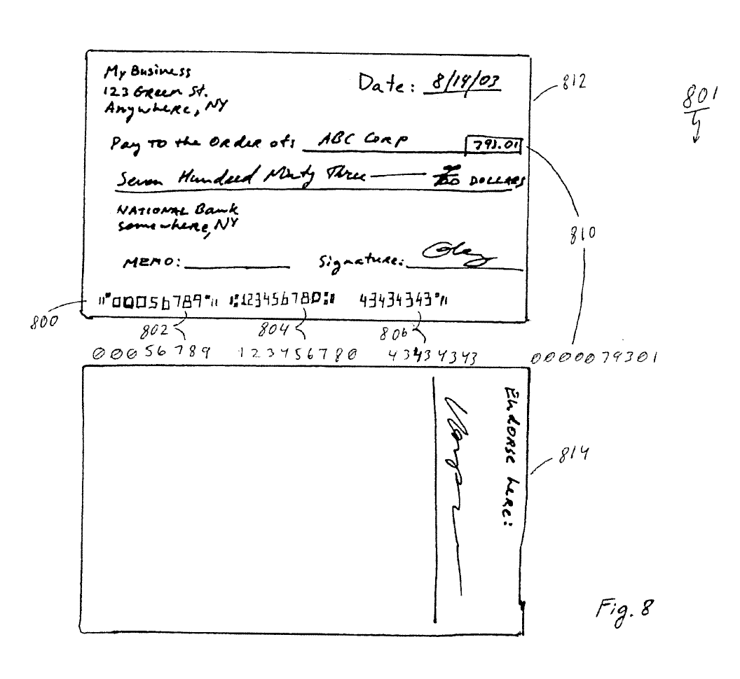

FIG. 7 shows a method for depositing consumer check records stored in the second subfile 132 according to the present invention. In step 700, ODFI 120 receives second subfile 132 containing the check records of consumer checks. In step 702 the ODFI 120 forwards the check records from second subfile 132 to the Clearing Network 122 in order to settle transactions referenced by the checks whose data is stored in second subfile 132.

Clearing Network 122 receives the records stored in second subfile 132. Clearing Network 122 may verify if the transactions ins second subfile 132 comply with various procedures. For instance, Clearing Network 122 may check for duplicate entries, amount of a check, the number of times a particular check has been presented, etc. Subsequently, Clearing Network 122 debits the debtor's RDFI 124 to deduct the amount 810 from the account of debtor 102 and that amount is credited to the account of creditor 104 by the creditor's RDFI 126. As stated above, second subfile 132 may be processed utilizing procedures for first subfile 130.

The present invention provides a single point of entry deposit for all checks, regardless if they are issued from consumer or non-consumer accounts. The creditor does not need to segregate the non-consumer checks and consumer checks and later take the non-consumer checks to its own financial institution for manual deposit. The creditor scans all the checks using the computer arrangement discussed above. After that initial step, the process is performed by various computers. The computers first digitize the checks and then sort the digital check records. Thus, the present system automates a previously time consuming activity: manual sorting of checks and the subsequent deposit of checks.

The system according to the present invention may be deployed on any number of computing devices. The exemplary embodiment discussed above included a dual-computer arrangement where the first computer generated the masterfile, which was later processed by the second computer. However, the entire system may be executed using a single computer. For instance, the creditor's computer (e.g., the first computer) may have all of the software installed that is necessary to generate and process the masterfile.

Alternatively, the second computer may control the entire process. In that situation, the first computer would simply serve as a remote terminal that would only allow the creditor to scan in the checks and would also display the sorting results for manual verification (e.g., using an applet 501 shown in FIG. 5). The second computer would control the scanner and all the other processes (e.g., the sorting process, settlement process, etc.). This embodiment diminishes a security risk that is associated with the other embodiments, namely susceptibility to manipulation through unauthorized access (i.e., by creditor) of the software installed on the first computer. As stated above the software application(s) are installed on the second computer, which may be located at a remote location (e.g., a data processing entity) where access to the software application(s) to third parties is limited. Thus, by utilizing the second computer, there is a decreased chance that the creditor or a third party can manipulate the electronic deposit process (e.g., forgery).

The invention is useable by Lockbox processors and big-budget creditors as an alternative check-deposit technology without needing to use an IBM 3890 machine. The invention also is useable by creditors at the other end of the spectrum, with only a relatively few paper checks, to accomplish remote-deposit.

The invention may be further appreciated with reference to the following Examples.

### EXAMPLE 1

### Consumer Check

A standard consumer check is 6 inches, the length of US currency, and also has same width as US currency, 2¾ inches. A consumer check in the US is almost never otherwise than currency-size.

### EXAMPLE 1A

### Non-Consumer Check

In this example, a business check is 8½ inches by 3½ inches.

### EXAMPLE 1B

### Non-consumer Check

In this example, a business check is 8 inches by 3 inches.

### EXAMPLE 1B

### Non-Consumer Check

In this example, a business check is 8 inches by 3⅜ inches.

### EXAMPLE 1C

### Non-Consumer Check

A non-consumer check on a US account is almost always larger than the size of US currency.

### EXAMPLE 1D

### Mixed Batch

By “Mixed Batch” herein, we mean a batch comprising at least one consumer check and at least one non-consumer check. Examples of a Mixed Batch include, e.g., a Mixed Batch comprising a check of Example 1 and at least one check selected from the group consisting of Example 1A, Example 1B and Example 1C. A Mixed Batch comprises 2 or more checks, and can comprise 10s, 100s, or 1,000s of checks.

### EXAMPLE 2

An inventive system was constructed and operated for processing a Mixed Batch. A Mixed Batch of checks including multiple consumer checks having the same size as US currency and multiple non-consumers checks of various sizes all larger than US currency were received as one batch, the Mixed Batch, into the system's single point of entry that was an office scanner. All of the checks in the Mixed Batch were remotely deposited, without any manual sorting of the checks into consumer versus non-consumer having occurred. The remote deposit was successfully concluded without any paper checks needing to be couriered forward to another geographic location.

### EXAMPLE 2A

### High Volume

In practicing the invention such as Example 2, Digital Check TS350, which accepts 100 checks at a time, has been used as the scanner, such as by businesses with a volume of 3,000-5,000 checks per day to be scanned.

### EXAMPLE 2B

### High Volume

In practicing the invention such as Example 2, Digital Check TS215, which is a single-feed check scanner for small volumes, has been used as the scanner.

### EXAMPLE 2C

### Mid Volume

In practicing the invention such as Example 2, Digital Check TS230/65, which accepts 25 checks at a time, has been used as the scanner, such as by business with a volume of 10-500 checks per day to be processed.

### EXAMPLE 2D

### Low Volume

In practicing the invention such as Example 2, MagTek Imager, which accepts a single check at a time, has been used as the scanner, such as by businesses who process 10 checks per day.

### EXAMPLE 2E

In this example, a human opens the mail and orients checks so they are facing upright and in a correct direction such as facing to the left all aligned top up and forward edge aligned into the scanner for feeding into a scanner according to the scanner's limit of how many checks can be placed into the scanner's feed slot.

A jogger is not necessary but is useful with volumes of checks.

### EXAMPLE 3

In this example, an inventive system processes a batch that comprises checks with a MICR line that consists of MICR font printed in ordinary ink, without using magnetic ink. Optical scanning is used to read the MICR-font lines consisting of ordinary ink.

### EXAMPLE 3A

In this example, an inventive system processes a batch that comprises checks with a MICR line that consists of MICR font printed in magnetic ink.

### EXAMPLE 3B

In this example, an inventive system processes a batch in which is included both checks with a MICR line that consists of MICR font printed in ordinary ink and checks with a MICR line that consists of MICR font printed in magnetic ink.

It will be apparent to those skilled in the art that various modifications and variations can be made in the structure and the methodology of the present invention, without departing from the spirit or scope of the invention. Thus, it is intended that the present invention cover the modifications and variations of this invention provided they come within the scope of the appended claims and their equivalents.

What is claimed is:

1. A remote check deposit method by which is deposited a Mixed Batch of checks comprising both a consumer check and a non-consumer check each comprising a Magnetic Ink Character Recognition (MICR) line comprising MICR-font characters, each MICR line having a format, without manual sorting of the non-consumer checks and the consumer checks prior to deposit, comprising:
scanning, into a single point of entry, the Mixed Batch of checks including the consumer check and the non-consumer check; followed by
electronically depositing both the consumer check and the non-consumer check, provided that no manual sorting of consumer checks from non-consumer checks has been performed before deposit.

2. The method of claim 1, wherein the Mixed Batch comprises at least one consumer check having a size of US currency, and at least one business check having a size substantially larger than US currency.

3. The method of claim 1, wherein the checks are not situated in any tray prior to the scanning step.

4. The method of claim 3, provided that the checks are not situated in any tray at any time before deposit.

5. The method of claim 1, wherein the Mixed Batch of checks comprises at least 100 checks, some of which are consumer checks and some of which are non-consumer checks, wherein the step of electronically depositing is accomplished for each and every check in the Mixed Batch.

6. The method of claim 1, wherein the Mixed Batch of checks comprises at least 1,000 checks, some of which are consumer checks and some of which are non-consumer checks, wherein the step of electronically depositing is accomplished for each and every check in the Mixed Batch.

7. The method of claim 1, wherein the Mixed Batch comprises at least one check of a first length, and at least one check of a second length that is longer than the first length.

8. The method of claim 7, wherein the Mixed Batch further comprises at least one check of a third length that is longer than the second length.

9. The method of claim 7, wherein the Mixed Batch comprises at least one check of a first width, and at least one check of a second width that is longer than the first width.

10. The method of claim 1, wherein the single point of entry is a desktop machine.

11. The method of claim 1, wherein the Mixed Batch comprises checks having a MICR line that consists of magnetic ink.

12. The method of claim 1, wherein the Mixed Batch comprises checks having a MICR line free of magnetic ink.

13. The method of claim 12, wherein the Mixed Batch comprises checks having a MICR line that consists of magnetic ink and checks having a MICR line free of magnetic ink.
